(19) United States
(12) Patent Application Publication
(10) Pub. No.: US 2002/0182737 A1
(43) Pub. Date: Dec. 5, 2002

(54) Process and device for recognition of a medium fraction, in particular in motor fuel

(76) Inventors: Holger Jungmann, Gelsenkirchen (DE); Martin Schmidt, Oberdorf (DE); Michael Schietzel, Herdecke (DE)

Correspondence Address: KATTEN MUCHIN ZAVIS ROSENMAN, 575 MADISON AVENUE, NEW YORK, NY, 10022-2585, US

(21) Appl. No.: 10/141,540

(22) Filed: May 8, 2002

(30) Foreign Application Priority Data
May 8, 2001 (DE) 101 22 109.6

(51) Int. Cl. G01N 21/64

(52) U.S. Cl. 436/56; 436/172; 422/82.08

(57) ABSTRACT

The invention relates to a process and a device for recognition and in particular quantification of a medium fraction in a translucent solution, in particular in a motor fuel. According to the invention, a process is proposed for recognition of the concentration of a fluorescent substance, in particular a marker, in a fluid to be examined in which a sample has been introduced into an examination space, in connection with an exposure step the examination space is trans-illuminated by a beam of light such that in the examination space one fluid segment interspersed by a beam of light and one fluid segment not interspersed by a beam of light are formed.

The invention relates to a process and a device for recognition and particularly for quantification of a medium fraction in a translucent solution, in particular in a motor fuel.

It is known that in consideration of their purpose, hydrocarbons are compounded with additives. For instance, industrial alcohol may be compounded with bitter principles and mineral oil may be dyed. Alcohols compounded with bitter principles or mineral oil dyed as heating fuel are taxed at lower rates and therefore available in retail at lower prices than the unbittered or undyed source stocks taxable at higher rates. By means of filtration or distillation methods it is however possible to remove the admixed medium fractions so that, for example, refined product commercialised as heating oil after filtration cannot be reliably distinguished from taxed diesel motor fuel.

It is an object of the present invention is to create a process and a device by means of which selected medium fractions can be recognised in organic fluids, such as motor fuels, quickly and in a reliable manner even when present in minor medium concentration.

This object is achieved according to the present invention by means of a process in which a sample of the fluid to be examined is introduced into an examination space radiated in connection with an exposure step with a beam of light in such a way that in the examination space a fluid segment interspersed with the light beam and one not interspersed with the light beam are formed, in connection with a first measurement step at a first distance a first fluorescent spectrum is determined from the fluid segment interspersed with the light beam and in connection with at least one additional measurement step of the fluid segment exposed an additional fluorescent spectrum is determined at a distance differing from the first distance and in connection with an evaluation step including the consideration of at least the two different fluorescent spectra the concentration of a fraction of the sample is calculated.

This makes it possible in an advantageous manner to prove reliably and in a short period of time of less than 30 seconds, for instance, the existence of additives of specific origin in an extremely small concentration in a motor fuel. With the aid of the process according to this invention other fluorescent compounds as well such as perfumes, alcoholic beverages, fluorescent antifreezes, oils, dyes and soaps can be distinguished from imitations or illicitly modified (e.g. diluted) variants. The process according to the invention is also suitable in general for determination of the concentration of fluorescent substances in solutions with a high degree of auto-fluorescence.

The fluid space segment intended for taking the sample is preferably formed by means of a cell so that the trajectory of the light beam traversed in the sample has a length in the range from 0.5 to 50 mm. It is also possible to form the segmentally illuminated fluid space segment by having a light emission range radiating the light beam immersed in the medium being examined as an analysis head.

Preferably, the intensity of the light beam entering the sample can be modified by way of adjustment. It is possible to undertake modification of the intensity of the light beam entering the sample by adjusting the power consumption of the light source provided for generating the beam of light.

Alternatively, or in a particularly advantageous way in combination with this measure, it is also possible to adapt the intensity of the beam of light penetrating into the sample with an optical filtration device so that the beam of light can be almost completely absorbed by the sample.

Under a particularly preferred embodiment of the invention, the length of the sample segment interspersed with the beam of light can be modified by adjustment.

It is possible in a particularly advantageous way to so thoroughly absorb the beam of light by means of the sample that in the final area of the examination segment the sample's fluorescent spectrum can be recognised while the light source's excitation spectrum is largely suppressed. In this connection it is possible in an advantageous manner to render samples with a low degree of absorption definedly turbid or to compound them with a substance of known fluorescence spectrum in order to obtain adequate ray absorption within the length of the examination segment. By means of the ray absorption thus attained it is also possible to pick up a fluorescence spectrum in which the fraction present in the small concentration no longer appears. The length of the examination space should advantageously be modifiable in the direction of the beam of light's diffusion.

On the basis of the light filtered through the examination medium it is possible to suppress the source of light and preferably as well the medium fraction present in negligible concentration largely in the remaining fluorescence spectrum. In interaction with the fluorescence spectra absorbed by the light-penetrated sample segment in differing distances according to this invention, a particularly high precision of determination can be achieved.

In regard to technicalities of a device, the object indicated at the outset is also solved by means of a device for recognising the concentration of a fluorescent substance in a fluid with an examination space for picking up a sample of the fluid to be examined, an illumination device for introduction of a light beam into the examination space in such a way that in the examination space a fluid segment interspersed with the beam of light and one not interspersed with the beam of light are formed, a measuring device for recognition of a fluorescence spectrum in connection with a first measurement step at a first distance from the fluid segment interspersed with the beam of light as well as for recognition of at least one additional fluorescence spectrum at a second distance different from the first distance from the illuminated fluid segment and an evaluation device for evaluation of the two different fluorescence spectra in order to determine the concentration of the fluorescent substance on the basis of deviations of at least two fluorescence spectra determined at differing distances from the beam of light.

Further details of the invention emerge from the following description in connection with the illustration. The figures show the following:

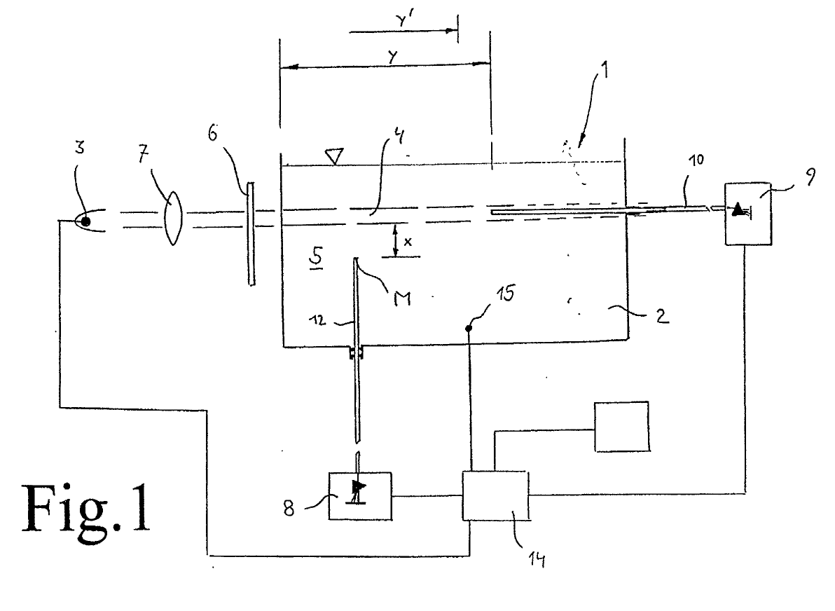

FIG. 1 A theoretical sketch to explain a preferred embodiment of a device according to this invention for showing a fluorescent marker admixed to a motor fuel;

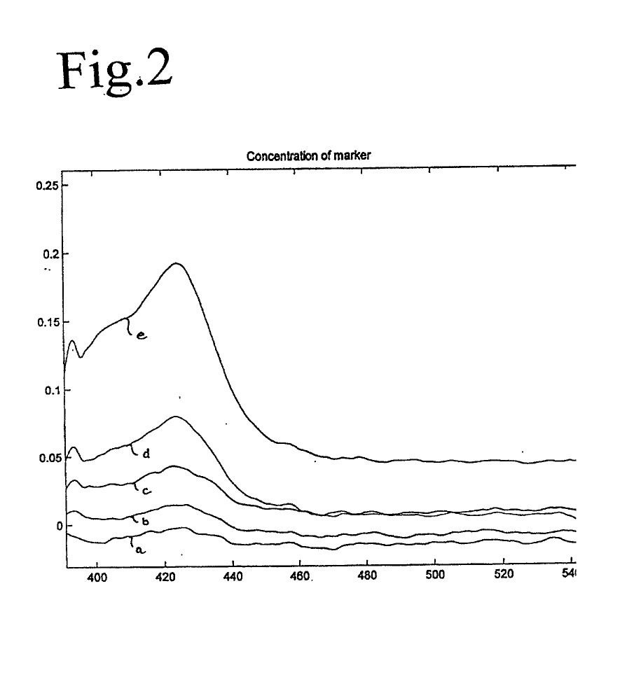

FIG. 2 A fluorescence spectrum of a motor fuel for differing concentrations of an admixed marker;

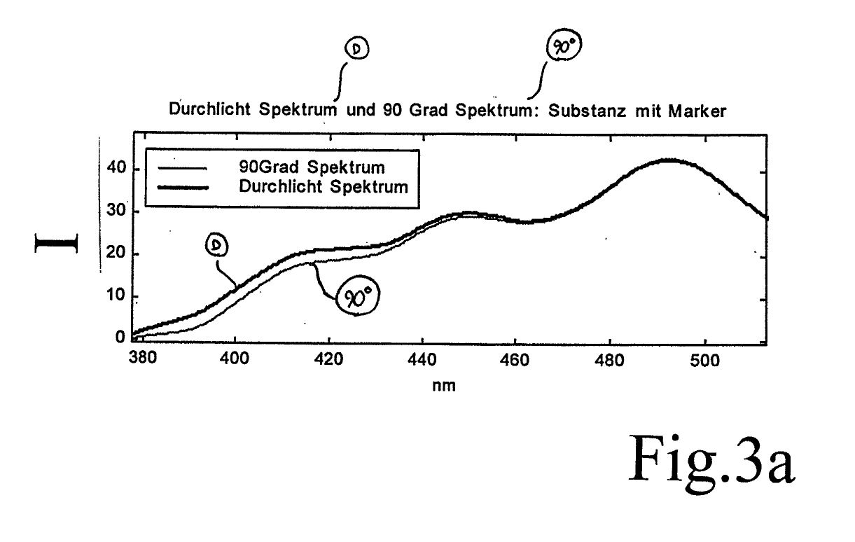

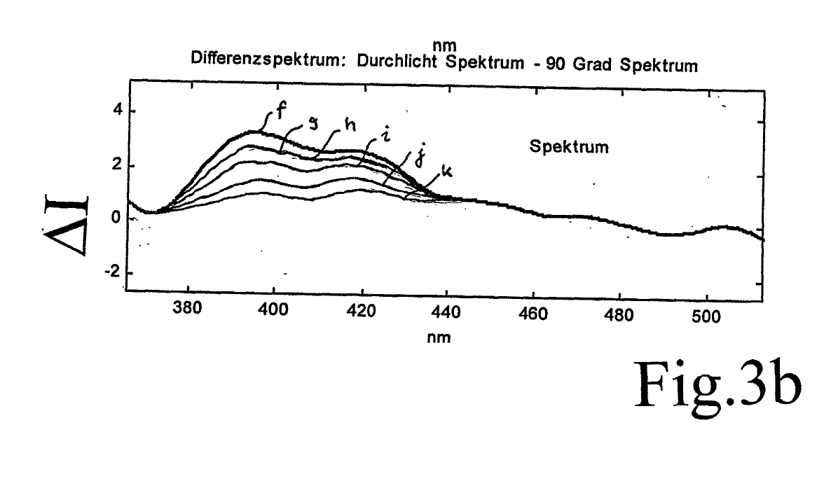

FIG. 3a A depiction to explain the differences between a trans-illuminated spectrum and a 90° spectrum;

FIG. 3b Several differential spectra as a function of the measurement distance X for a given marker concentration.

FIG. 1 shows in simplified form the structure of a device according to the present invention with a space for taking samples 1 which is here formed by a cell. The space for taking samples has in this example a length of about 18 mm and a volume of 0.8 ml. In the space for taking samples 1 there is a sample 2 to be examined, e.g. a fluorescent motor fuel.

The space for taking samples 1 can be trans-illuminated by means of a source of light 3 so that in the space an illuminating light trajectory segment 4 and a non-illuminated sample segment 5 lying outside of the radiation trajectory adjacent to the former segment are produced.

The intensity of the light penetrating into sample 2 is adjustable by controlling the power supply of light source 3 as well as with a filtering device 6. For focussing the light a lens device 7 is additionally provided for.

Via a first spectrometric device 8 it is possible to recognise the spectrum of the fluorescent light emitted up to a first measurement point M in sample 2 perpendicular to the beam of light's direction of diffusion. The distance of the measurement point M from the trans-illuminated light trajectory segment 4 of sample 2 can be modified by way of adjustment. In the embodiment shown, the distance can be modified by moving an outward-facing front-segment constituting measurement point M of a wave guide 12 in an adjustable manner either closer to or further away from the light trajectory segment 4.

Via a second spectrometric device 9 it is possible to recognise the light diffused in the direction of light trajectory segment 4. The recognition point of the light diffusing in the direction of light trajectory 4 as well as the intensity of sample 2 of the segmentally trans-illuminating light can be adapted such that both the light emitted for excitation of the sample by light source 3 as well as the fluorescent light emitted on the part of a substance to be detected contained in sample 2 are largely absorbed by sample 2. In this way it becomes possible to pick up a fluorescence spectrum via the second spectrometric device 9 which basically corresponds to the fluorescence spectrum of the main fraction of sample 2. In the embodiment shown here a suitable length of the light trajectory segment 4 can be set by making it possible to insert a wave guide 10 in adjustable manner into light trajectory segment 4. Modification of the length y of the light trajectory segment 4 up to the point of sensing the fluorescent light can be achieved in other ways as well.

The fluorescence spectra determined by the first spectrometric device 8 as well as by the second spectrometric device 9 are fed to an evaluation device 14.

The evaluation device moreover in this embodiment recognises the temperature of sample 2 by means of a temperature sensor 15, the distance x of measurement point M from the light trajectory segment 4 as well as the length y of the light trajectory segment 4 up to the point of sensing the fluorescence spectrum by the second spectrometric device 9. The intensity of the excitation light generated by light source 3 is likewise recognised by the evaluation device 14.

For determination of the portion of a fluorescent fraction in the totally fluorescent sample 2 the following analytical steps in particular are processed by the evaluation device:

At first a suitable length y′ is set at which the excitation light from light source 3 is largely absorbed by sample 2. Optionally, it is possible to increase the length of light trajectory segment 4 to a magnitude y at which it can be assumed that the additional fraction will no longer make its appearance in the fluorescence spectrum. The fluorescence spectrum recognised with this system setting by spectrometric device 9 is stored by evaluation device 14.

Preferably in tandem with this action, the fluorescence spectrum of the fluorescent light diffusing in the direction of measurement point M perpendicular to light trajectory segment 4 is measured under a first distance x. This measurement is repeated for several different distances x where the fluorescence spectra determined in each case are stored.

The fluorescence spectra determined make possible an unambiguous determination of the concentration of a fluorescent substance contained in negligible amounts in sample 2.

This evaluation is based on the solution concept that the fluorescent light diffusing in sample 2 perpendicular to the light trajectory segment 4 is itself absorbed by the sample. The differing absorption degrees caused in this case by differing wavelengths of the fluorescent light result in deviations between the fluorescence spectra recognised by the first spectrometric device 8 (at differing distances). These deviations are unambiguous (particularly in regard to concentration) if the fluorescence of the marker is significantly less than the fluorescence of the motor fuel. The process is thus suitable to a particular extent for such negligible marker fluorescence intensities where the marker fluorescence is practically swallowed up by the total fluorescence.

FIG. 2 shows a slew of fluorescence spectra a through e for differing concentrations of a fluorescent marker in a diesel motor fuel. On the abscissa the concomitant wavelengths have been charted. On the ordinate the intensity of fluorescence has been charted. The graph e shows the fluorescence spectrum at a concentration of Q1. The graphs a through d show the intensity of fluorescence above the wavelength at concentrations of 9.1% Q1, 16.6% Q1, 25.0% Q1 and 50.0% Q1.

These fluorescence spectra emerge from measurement at a measurement point (spectrometric device 8) distanced from the sample segment directly interspersed with the beam of light. To be recognised is the peak of optic density characteristic of the marker being examined at a wavelength of about 420 nm.

FIG. 3b depicts several differential spectra f through k plotted by the spectrometric device 8 for increasing distances X from the light trajectory segment 4 (FIG. 1). From this slew of fluorescence spectra f through k, the concentration of a fluorescent marker in a likewise fluorescent fluid (in this case diesel motor fuel) can be calculated in connection with the distance X set for each spectrum. From the modification of intensity of fluorescence at the various different points the absorption of the medium emerges as explained here below with reference to the measurement arrangement in FIG. 1. Assume 10 (λ) or I1 (λ) is the excitation intensity radiated, E0 (λ) or E1 (λ) the intensity occurring at 9. Because of I0(λ)/E0(λ)=exp(−εcd) (Lambert-Beer's Law where ε is the extinction constant, c is the concentration and d is the length of the light trajectory), εc can be determined immediately since d is known. The solution's optical properties are thus known. For this reason, with M from the two distances x1 and x2 the absorption of marker fluorescence by the solution can be determined by εc(x1-x2). From the modification of marker fluorescence at x1 and x2 and from the solution's known εc Lambert-Beer unambiguously yields the marker concentration.

The precision of the marker concentration basically corresponds to the precision of εc. The radiation intensity I0(λ) is not identical to the intensity with which the radiated light penetrates into the substance. Thus as a function of the differing refraction indices of differing solutions a different amount of light is reflected that does not get into the solution. From the differential measurement at 9 with differing intensities I0(λ) and I1(λ) by calculation of a corrective function this circumstance can be taken into account. Besides determination of the marker fluorescence, measurement at 9 preferably serves for more precise determination of the solution's εd. This method is particularly precise where εd+ε(marker)*c(marker)≈εd, where the marker thus accounts for only a small portion of total absorption. Therefore this method is particularly suitable for quantitative determination of negligible marker concentrations.

The distance X set for plotting the fluorescence spectrum f is 0.8 mm. The distance X when plotting the fluorescence spectrum k is 12 mm. The distances set when plotting the spectra g through j lie at equal intervals between these two extreme values.

The light source can preferably be formed by a commercially available diode where the choice of the diode is made such that its light has a specified distance to the wavelength at which the fluorescence maximum lies in regard to the fluorescent substance to be determined by its concentration.

1. Process for recognition of the concentration of a fluorescent substance, in particular a marker, in a fluid to be examined in which
a sample has been introduced into an examination space,
in connection with an exposure step, the examination space is trans-illuminated by a beam of light in such a directed way that in the examination space a fluid segment interspersed by the beam of light and a fluid segment not interspersed by the beam of light are formed,
in connection with a first measurement step at a first distance a first fluorescence spectrum is determined from the fluid segment interspersed by the beam of light,
in connection with at least one additional measurement step, an additional fluorescence spectrum of the trans-illuminated fluid segment is determined at a second distance differing from the first distance,
in connection with an evaluation step the concentration of the fluorescent substance is determined from the two differing fluorescence spectra.

2. Process according to claim 1 characterised in that in connection with a reference measurement step a reference spectrum is recovered from a sample segment illuminated from behind a light beam front range lying in the direction of light diffusion.

3. Process according to claim 2 characterised in that for measurement of the reference spectrum the intensity of the beam of light or the length of the sample segment traversed by the beam of light is adjusted such that the reference spectrum essentially only contains the fluorescence spectrum of the sample's main fluorescent component.

4. Process according to claim 3 characterised in that absorption of the solution is determined from differential measurement regardless of the reflection properties of the medium to be examined.

5. Process according to claim 4 characterised in that the distance of the measurement points to the beam of light is varied in a direction running perpendicular to the beam of light.

6. Process according to claim 5 characterised in that the distance to the fluid segment trans-illuminated is modified by shifting the beam of light.

7. Process according to claim 1 characterised in that the distance to the beam of light is modified by modifying the distance of the end of a light penetration of a wave guide from the segment of the sample interspersed with the beam of light.

8. Process according to claim 1 characterised in that calculation of the concentration of fluorescent medium fractions is accomplished by assuming that there is a connection between the deviations of the fluorescence spectra measured at differing distances to the beam of light, the concentration and the distance from the beam of light.

9. Device for recognition of the concentration of a fluorescent substance in a fluid with an examination space for taking a sample of the fluid to be examined,
an illumination device for introducing a beam of light into the examination space such that in the examination space a fluid segment interspersed by the beam of light and a fluid segment not interspersed by the beam of light are formed,
a measuring device for recognition of a fluorescence spectrum in connection with a first measurement step at a first distance from the fluid segment interspersed by the beam of light as well as for recognition of at least one additional fluorescence spectrum in a second fluid segment trans-illuminated at a second distance differing from the first distance,
and an evaluation device for evaluation of the two differing fluorescence spectra, for determination of the concentration of the fluorescent substance on the basis of deviations of at least two fluorescence spectra determined at differing distances from the beam of light.

10. Device according to claim 9 characterised in that the light of the beam of light has a wavelength in the range from 300 to 450 nm.

11. Device according to claim 9 characterised in that the light of the beam of light has a wavelength in the range from 385 to 395 nm.

12. Device according to claim 1 characterised in that the beam of light has a diameter in the range from 0.5 to 4 mm.

13. Device according to claim 9 characterised in that the light is generated by a diode light source.

14. Device according to claim 9 characterised in that the examination space is formed by a cell.

15. Device according to claim 9 characterised in that the length of the examination space measured in the direction of diffusion of the light can be modified by way of adjustment.

16. Device according to claim 9 characterised in that the intensity of the light beam can be modified by way of adjustment.
